(19) United States
(12) Patent Application Publication
(10) Pub. No.: US 2002/0016779 A1
(43) Pub. Date: Feb. 7, 2002

(54) Method and system of providing competitive comparative terms to the user

(75) Inventors: Richard J. Roll, Stamford, CT (US); Gregory M. Bibas, New Canaan, CT (US)

Correspondence Address: Charles N. J. Ruggiero, Esq., Ohlandt, Greeley, Ruggiero & Perle, L.L.P., 10th Floor, One Landmark Square, Stamford, CT, 06901-2682, US

(73) Assignee: REALHOME.COM

(21) Appl. No.: 09/916,781

(22) Filed: Jul. 27, 2001

Related U.S. Application Data
(60) Provisional application No. 60/221,809, filed on Jul. 31, 2000.

(51) Int. Cl. G06F 17/00

(52) U.S. Cl. 705/400

(57) ABSTRACT

The method and system of the present invention provides a comparative and variable pricing system that allows users to enter an item request regarding a specific product or service in which they have an interest, submit such information to a host provider, and receive back a comparative list of providers of that item, as well as terms of offer for the item. The system allows for both retail and wholesale pricing to co-exist, and for a variable pricing mechanism to be applied to products, services and/or service available from the host provider, in connection with the prices available elsewhere in the market.

### BACKGROUND OF THE INVENTION

1. Field of the Invention

The present invention relates to comparison shopping methods and systems and in particular, to a method and system for systematically organizing and providing access to multiple providers of products and services in a competitive, comparative process. The present invention enables users to determine the best terms for the purchase of an item, and the system utilizes a variable pricing model to determine the terms of offer for items or services available from a host provider.

2. Description of the Related Art

There are currently various mechanisms that allow comparative price research for products and services. These current mechanisms include, but are not limited to, advertisements in magazines; mortgage rate pages showing mortgage rates from various providers in a tabular, side-by-side format; coupon mailers showing various manufacturers promoting similar products; Internet web sites which search other web sites based on a particular product and return the prices available from other sites (e.g., shopping bots); and auction and reverse auction Internet Web sites and other services. Each of the above-mentioned services provide some comparable pricing for users to determine the cost of a particular item in the market at a particular point in time.

In addition, some of these services provide a “Lowest price guarantee”. Such lowest price guarantees are rarely enforced, and require additional work on the part of the consumer to obtain, as compared to the consumer actually obtaining the actual lowest market price.

Heretofore, available pricing mechanisms are primarily designed to promote transactions within either a) the line of service of the entity providing the listing (e.g., auctions, shopping Internet web sites, mortgage company web sites, insurance company web sites, retail stores and discount stores); or b) through a service provider at or by another vendor (e.g., coupon mailers, Internet Web sites that allow users to obtain pricing information from multiple provider sites, and Internet Web sites that offer the products of competing providers through their web site, providing consumers with comparative choice).

Users may use these various pricing mechanisms in an effort to find the best terms for the purchase of an item. However, the users' motivation can be in conflict with the motivation of the entitiy providing the pricing information, often the seller. The seller's motivation is oftentimes to maximize profit, which means conducting the highest number of transactions with the highest margin possible.

Previous variable pricing systems have allowed consumers and/or businesses to bid on a particular product or a service through an auction; bid on a product or a service through a reverse auction where some parameters are flexible, thereby allowing vendors to counter-bid; and/or conditional purchase offer systems incorporating elements of reverse auctions and contractual purchase obligations; and directory listing systems similar to classified advertising, which allows various vendors to offer products that may or may not be similar, for varying prices.

The above examples illustrate the existing demand by buyers, including but not limited to consumers and businesses, for more information, better control over the purchasing process, and a competitive/comparative system in which the user is in control of the purchasing transaction process and the vendors are competing in a marketplace for the user's business.

### SUMMARY OF THE INVENTION

It is an object of the invention to provide a comparative shopping system that determines the best terms for products and services from product/service providers.

It is another object of the invention to offer products and services from a host provider and price those items in a variable manner based upon the information provided to the system by other participating product/service providers and/or general market research on prices.

It is still another object of the invention to allow users to query the system and receive a consolidated summary of the offers for the particular items being offered from all product/service providers, including the host provider of the system.

It is yet another object of the invention to enable the purchase of products and services from competing product/service providers.

It is yet another object of the invention to enable the purchase the products and services directly from the host provider.

It is a further object of the invention to allow product/service providers to receive compensation for selling items through the system.

It is still a further object of the invention to generate compensation for the host provider from product/service providers that offer items using the system.

It is yet a further object of the invention to enable information, such as information users' query and purchasing history data, and other data to be stored for further variable price generation, offers and/or further analysis.

Accordingly, the present invention is directed to a method and system for systematically organizing and providing access to multiple providers of products and services in a competitive, comparative manner. A user can determine the best terms for the purchase of a product, service and/or financial instrument. The system uses a variable pricing model to determine the pricing of items offered to users by a host provider of the system. As used herein, a term of offer includes terms of offer, and an item for purchase includes, but is not limited to, a product, service and financial instrument. As such, an object of the present invention is to provide a user with a system that provides a term of offer for a wide selection of products, services, financial instruments, providers and terms in a convenient manner.

Applications for the method and system of the present invention include, but are not limited to, pricing mechanisms for insurance, loans, credit cards, automobiles, and other consumer pricing applications. Some of the other pricing applications may include, for example, applications for business-to-business pricing (e.g., pricing for business supplies, services, raw commodities, processed goods, and transactions between business exchange marketplaces to cover demand) as well as comparison and optimization of nonfinancial business terms negotiation. There are many additional applications for the present invention mechanism, including all segments of the consumer and business marketplaces.

The present invention includes a method and system for providing a comparative listing of providers of an item constituting a product and/or a service, or financial instrument over a communication network by a host provider. The method includes requesting terms of offer for an item using a data requester device; obtaining the requested terms of offer for the item from at least one product/service provider, where the requested information is in a database; adjusting the terms of offer for the item from the host provider, in response to obtaining the requested terms of offer for the item from the product/service provider(s); and presenting the requested terms of offer for the item obtained from said product/service provider(s) and the adjusted terms of offer from the host provider to a user over the communications network.

The method and system are further operative to allow for the host provider to be compensated for (i.e., products, services and/or financial instruments) sold by other product/service providers, and for the host provider of the system to earn a margin on items purchased by users of the system.

### BRIEF DESCRIPTION OF THE DRAWINGS

FIG. 1 is a top level illustration of an embodiment of the present invention;

FIG. 2 is a depiction of a data requester device of the invention of FIG. 1;

FIG. 3 is a depiction of a product/service provider system of the invention of FIG. 1;

FIG. 4 is a depiction of a host provider of the invention of FIG. 1;

FIG. 5 is a depiction of a data structure for a customer record of FIG. 4;

FIG. 6 is a summary of a data structure for externally available demographic data of FIG. 4;

FIG. 7 is an embodiment of a data structure for purchase history data of FIG. 4;

FIG. 8 is an embodiment of a data structure for the item offered of FIG. 4;

FIG. 9 is an embodiment of the data structure for a provider database of FIG. 4;

FIG. 10a is a flow diagram of a preferred method of the invention;

FIG. 10b is a flow diagram of a remainder of the preferred method of the present invention;

FIG. 11 is a flow diagram for loading item information by the host operator in accordance with the present invention;

FIG. 12 is a flow diagram for allowing product/service providers to manage, update and control data in accordance with the present invention; and

FIG. 13 is a flow diagram of a product/service pricing engine in accordance with the present invention.

### DETAILED DESCRIPTION OF THE INVENTION

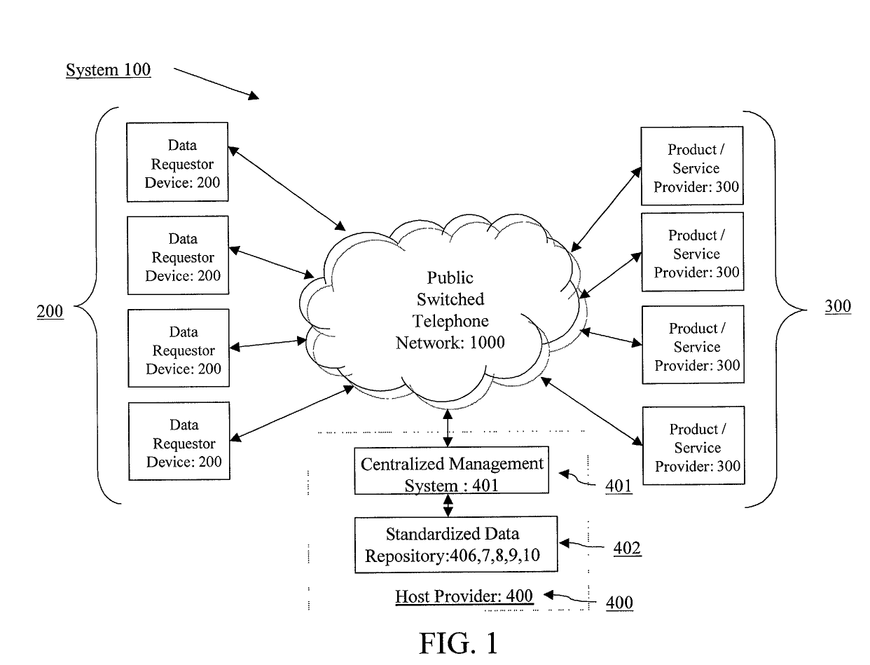

In FIG. 1, there is shown one aspect of the present invention. System 100 organizes and provides access to multiple providers 300 of products and services, including a host provider 400, in a competitive, comparative process. The method and system of the present invention enables one or more users to determine the best terms for the purchase of a product or service. The competitive, comparative system 100 uses a variable pricing model to determine the terms of offer for products/services offered to users from the host provider.

System 100 includes one or more data requester devices 200, a communications network, in the embodiment shown the communications network is a public switched telephone network 1000 (hereinafter PSTN), one or more product/service provider interfaces 300; and a host provider 400, including a Centralized Management System 401 (hereinafter CMS) and a standardized data repository 402. The system 100 may include multiple host providers. In the case that there are multiple host providers 400, host providers 400 are preferably ordered or prioritized. The ordering or prioritizing may be based on the type of item (i.e., product) for which data is requested (e.g., pricing data), customer preference, or some other method. Host provider 400, the data requester devices 200 and the product/service provider interfaces 300 are preferably connected to the PSTN 1000 through two-way communications links.

Users of system 100 can preferably access system 100 using the data requester device 200. Data requester device 200 provides a user interface to facilitate input of item (i.e., product and service) requests. The user interface may be graphical and/or textual. Retailers, wholesalers, resellers, etc. willing to offer their products and/or services through system 100 can access system 100 by way of the product/service provider interface 300. The flow of data between data requester devices 200, products/service provider interface 300, and host provider 400 is preferably controlled, coordinated and limited by host provider 400.

Although depicted in FIG. I as a PSTN, communications network 1000 can include a computer network such as the Internet or a LAN. It should be appreciated that communications network 1000 can include wired or wireless communications networks, or a combination thereof.

An example of the system 100 in operation entails a user, such as, for example, a shopper in a retail store, using the data requester device 200, which is, for example, a mobile phone or other handheld telecommunication device (e.g., a personal digital assistant (PDA)) to request information about a particular product or service (item), automatically receiving a price comparison of the item as offered by at least one, but preferably, a number of providers, including the host provider 400. The user is enabled to purchase the item using the wireless phone or other handheld telecommunication device should the user prefer the price (terms of offer) from the providers and/or the host provider listed in the price comparison.

In the example above, the item information request can be entered into data requester device 200 either manually or automatically. Such automatic entry formats include bar code scanning or other automatic data entry mechanisms for entering the information related to the product/service to be purchased. In one aspect of the present invention, the user (e.g., a shopper) may query the system for information. Such information includes, but is not limited to, model information, retailers selling the item, pricing for the item, and other types of item related data.

Data requester device 200 routes the data request to PSTN 1000 and to host provider 400. Host provider 400 preferably has a centralized management system 401 that analyzes the data request, routes the data request through a data management layer, and obtains data related to the item as provided from product/service provider interfaced with system 100 via product/service interface 300. The product/service data can be accessed from a standardized data repository 402. The data request is routed from host 400 to PSTN 1000 and to product/service provider interface 300. The product/service providers in turn satisfy the data request and send the requested pricing information and/or other terms of offer for the requested item through PSTN 1000 to host provider 400.

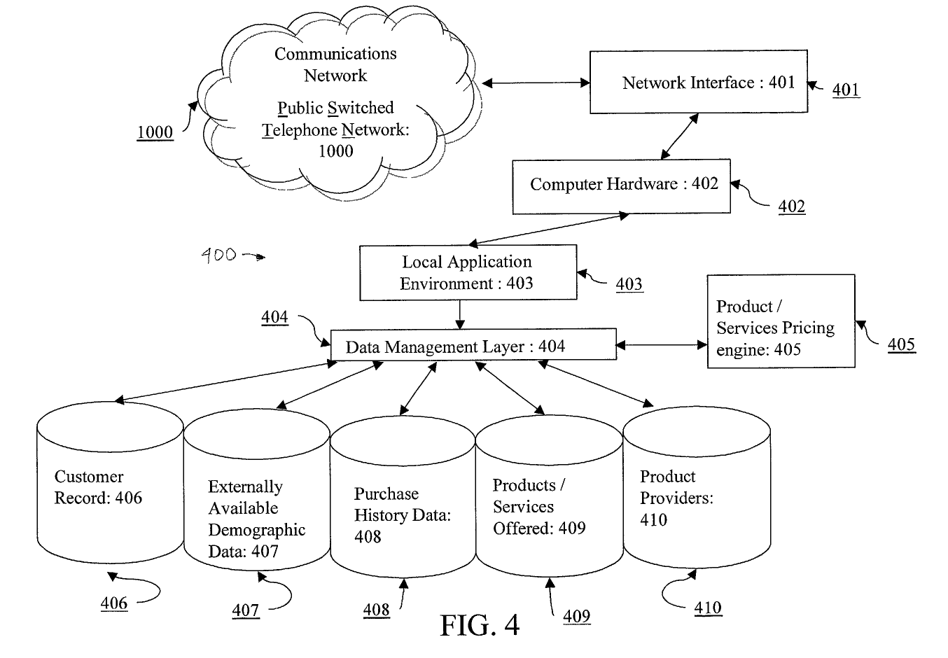

Host provider 400 uses the item information obtained from the product/service provider(s) 300 to determine and variably adjust the price or other terms of offer that host provider 400 is willing to extend to the requesting user for the requested item. In the event that host provider 400 determines not to offer the requested item data to the requesting user, host provider 400 does not provide a variably price adjusted item to the user of its own offering. Adjusting the terms of offer extended by the host provider 400 takes place in a product/service pricing engine 405, preferably forming part of host provider 400, as shown in FIG. 4. Host provider 400 sends the terms of offer for the item from the product/service providers 300 and the host provider 400 to the user over communications network 1000.

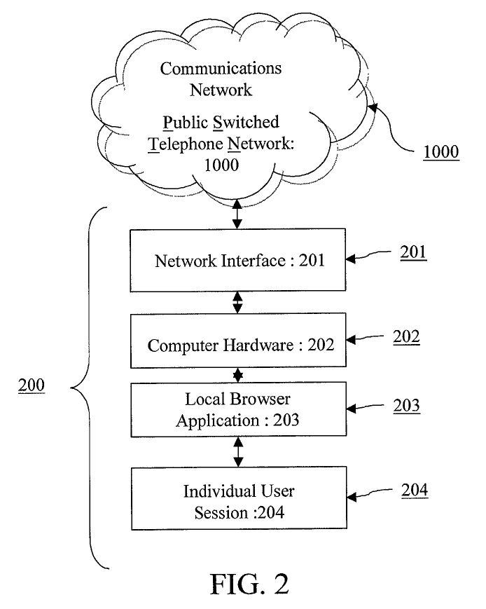

In one aspect of the present invention, an embodiment of data requester device 200 is depicted in FIG. 2. A user can initiate an individual user session 204 on data requester device 200 to, for example, commence a comparative, competitive pricing session. Data requester device 200 can be a personal computer, an Internet appliance, a PDA, a mobile phone, or etc. that can communicate electronic data.

In an aspect of the invention, a local browser application 203 provides a user interface on data requester device 200. The browser accesses the associated hardware 202 of the particular data requester device 200 and identifies the network interface 201 that facilitates access to PSTN communications network 1000. PSTN communications network 1000 is employed to connect the data requester device 200 to the host provider 400.

Again, it should be appreciated that the user can enter information into the data requester device in a number of different ways, depending on the particular embodiment of data requester device 200 used. Such input devices include, but are not limited to, a keyboard, a mouse, , an optical scanning device, a voice recognition system and other data input methods, and/or devices.

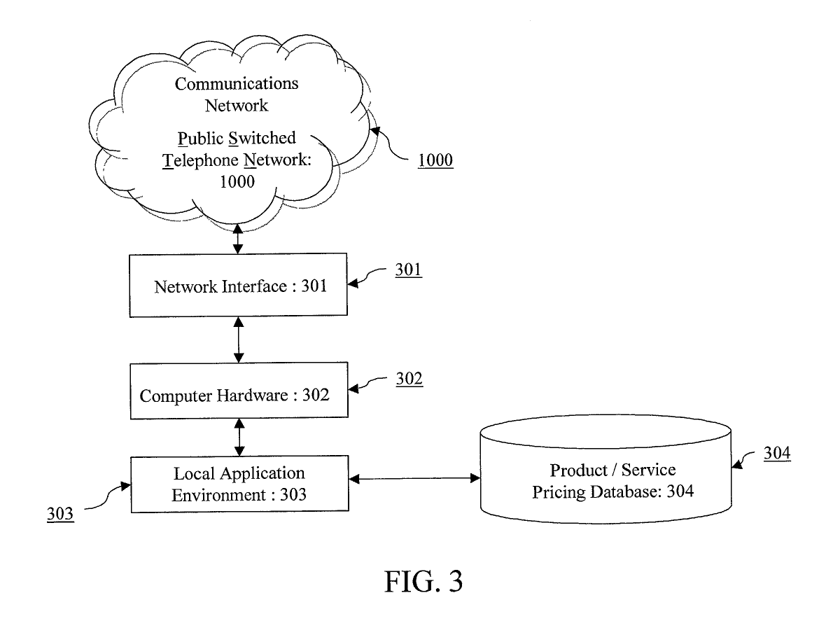

FIG. 3 illustrates an embodiment of the product/service provider 300 in accordance with the present invention. Data related to the terms governing the conditions product/service providers offer their products and/or services reside in a product/service are provided in pricing database 304. Product/service providers may elect to provide pricing and/or other item terms from a central or distributed database on the system 100 (e.g., CMS 401) or from their own maintained database. The product/service provider connects to communications network 1000 via network interface 301 that is accessible by computer hardware 302. A local application environment 303 also resides and runs on computer hardware 302. Local application environment 303 may include software operating systems, data management systems, database systems, and other software systems that allow for the management, access and control of the data stored in product/service pricing database 304.

FIG. 4 illustrates an embodiment of the internal functioning of host provider 400 in accordance with an aspect of the present invention. Various data repositories, 406 to 410, are preferably managed by a data management layer 404 of host provider 400. Data management layer 404 preferably acts to control flow, access and storage of the data used by the present invention based upon the authorization data provided in an item data request. Data management layer 404 can reside within a local application environment 403 that runs on associated computer hardware 402. A network interface 401 is used to establish communications with the communications network 1000.

In another aspect of the present invention, requests from data requester device 200 are routed to host provider 400. The data request is fulfilled by the host provider 400 through data management layer 404 based on the availability of the data, the level of access permitted, and the actions requested by a user in the item data request.

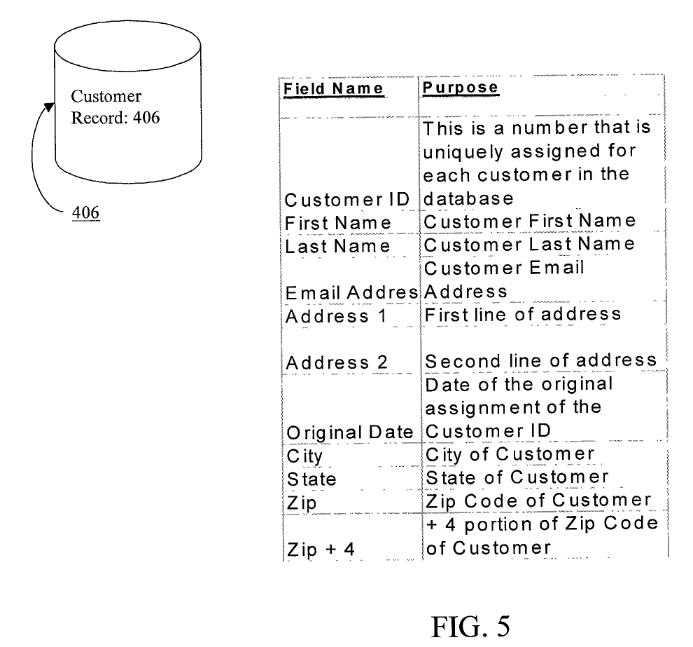

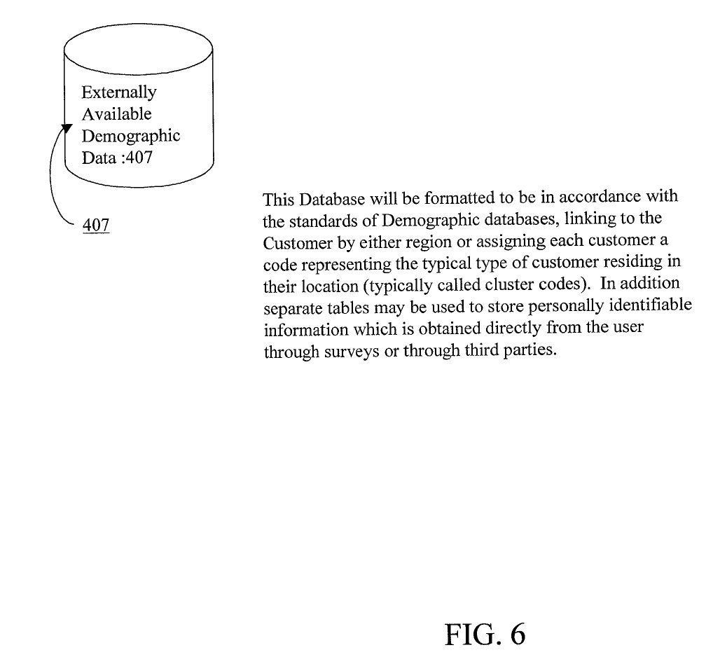

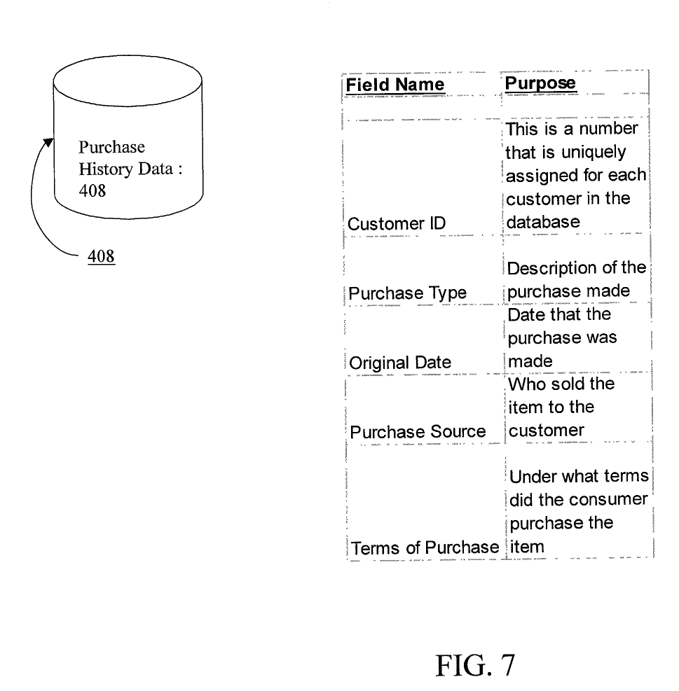

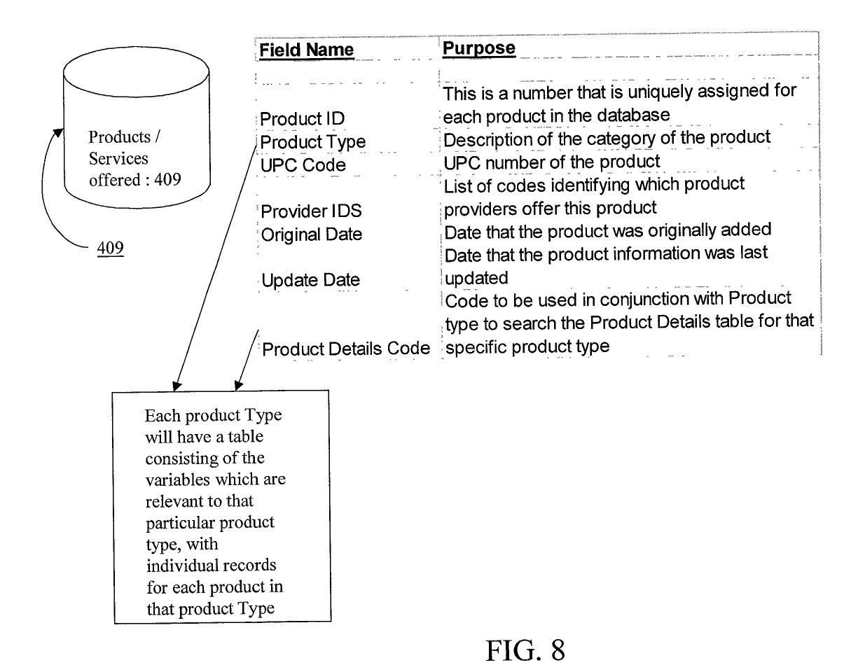

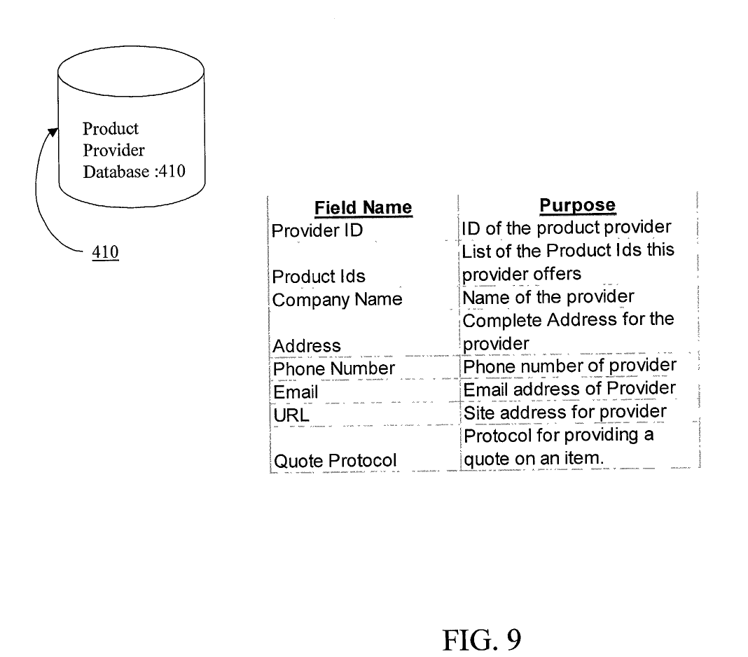

FIGS. 5 through 9 provide detailed, exemplary illustrations of the databases 406 through 410, respectively, coupled to the data management layer 404 in FIG. 4. It should be appreciated that the exemplary field names and descriptions provided in FIGS. 5 through 9 are exemplary, and not exclusive, of the content of the databases coupled to data management layer 404. In particular, FIG. 5 is a depiction of a data structure for a customer record. FIG. 6 is a summary of a data structure for externally available demographic data. FIG. 7 is an embodiment of a data structure for purchase history data of database 408. FIG. 8 is an exemplary embodiment of a data structure for the item offered, as stored in database 409. FIG. 9 is an aspect of the data structure for a provider database 410.

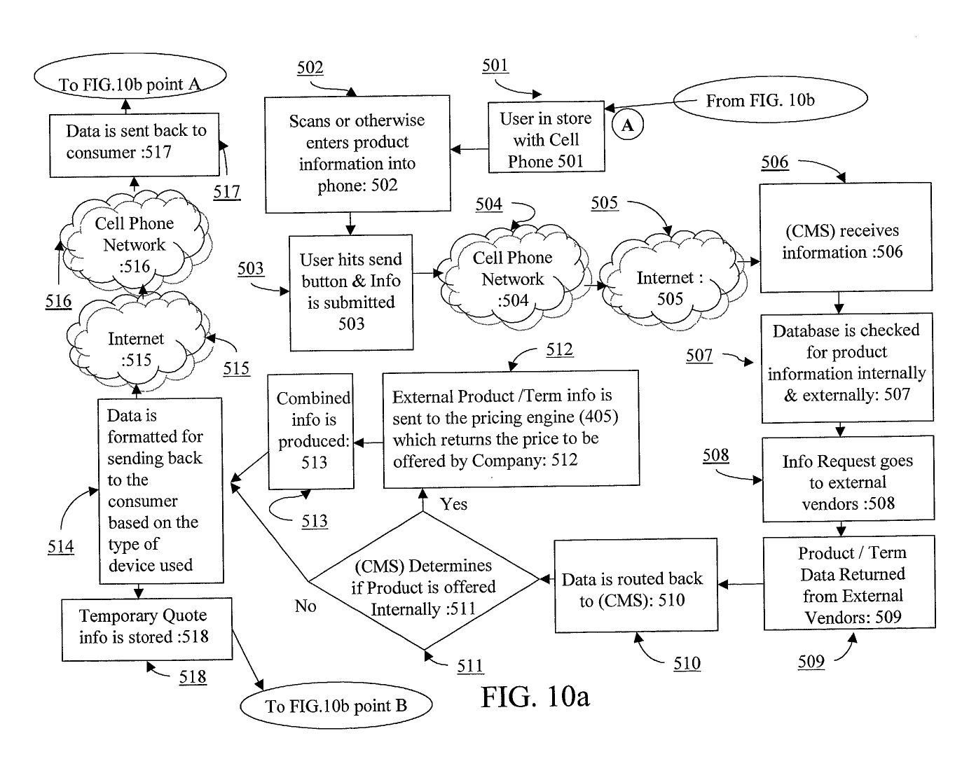

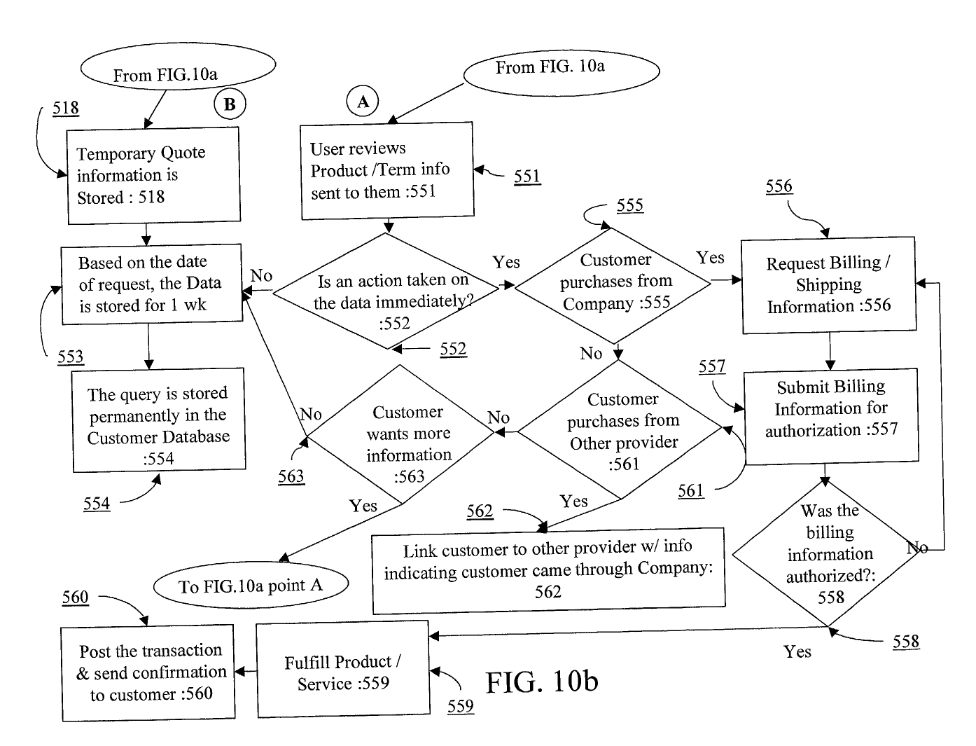

FIG. 10a illustrates a flow diagram in accordance with the present invention. It is noted that FIG. 10a depicts an aspect of the present invention implemented to effectuate retail comparison shopping. For example, a user in a retail store with a mobile phone (step 501) enters an item data request into data requester device 200 (step 502). The mobile phone acts as the data requester device in this example. The user submits the item data request by pressing a button or buttons on the mobile phone (step 503). The item data request is communicated through the mobile phone network (step 504), which connects and transmits the data to the Internet (step 505). The item data request is communicated to host provider 400(step 506). Host provider 400 routes the item request to the data management layer where the host provider checks the product/service database for the requested item information (step 507). Based on the data in the database, the various product/service provider interfaces 300 offering the requested item are identified, and the information request is dispatched to product/service providers (step 508) for the requested item. The terms of offer (e.g., price, availability, shipping date, shipping charges, etc.) for the requested item is provided by the product/service providers (step 509), and routed to the host provider 400(step 510).

Host provider 400 determines if the requested item is or will be offered by the host provider (step 511). If host provider offers the requested item, then the requested item request data is dispatched to the pricing engine (step 512). The pricing engine provides the price (or other terms of offer) that the host provider 400 is willing to extend to the user. In step 513, the terms of offer for the item from the host provider is combined with the terms of offer information returned from the product/service providers in step 510 to produce a consolidated comparative list of the product/service providers offering the product and the pricing being available from product/service providers. In step 514, this combined data is then formatted for transmission and presentation to the user.

At step 511, in the case where host provider 400 does not offer the item itself, the data obtained from the product/service provider(s) in step 510, is presented to the user in accordance with step 514.

From step 514, a temporary quote is preferably stored (step 518) and simultaneously transmitted through communications network 1000 (e.g., the Internet) (step 515) and the mobile phone network (step 516) to data request device 100 (step 517).

FIG. 10b is a continuation of the flow diagram of FIG. 10a and illustrates aspects of actions that typically occur subsequent to the return of a data request to data request device 100. In step 551, the comparative data sent to the mobile phone information returned (step 517) is reviewed by the user. A determination is made by the user as to whether to take further action on the returned item request data (step 552). If no further action is taken, then the temporary quote data (step 518) may be stored for a period of time (e.g., one week or some other variable period of time as determined, for example, by the user, host provider 400, or some other aspect of system 100), pending action during the time period. The data request (i.e., query) may be stored in a customer database (step 554) for further use and/or analysis.

If an action is taken on the returned item data request (step 552), then a determination is made whether the user is making a purchase from the host provider 400 (step 555). If the user indicates a desire to purchase the item from host provider 400 (step 556), then information related to billing and shipping is preferably requested from the user. The billing and shipping information is then submitted for authorization (step 557). If the authorization is not approved, the user is returned to step 556, where additional information is requested. If the authorization is approved, then the requested product or service are fulfilled (step 559), and the transaction is posted, thereby completing a charge and transaction to the customer (step 560).

Referring back to step 555, in the instance the user does not purchase the requested item from the host provider 400, the user may still purchase the item from one of the other product/service providers included in the comparison pricing list presented to the user. A determination is made (step 561), based on the user's indication, as to whether the customer wishes to purchase from one of the product/service provider listed in the pricing information presented. If the user decides to purchase from a product/service provider (step 562) the user is linked to that product/service provider.

In an aspect of the present invention, data indicating that the user was forwarded to the selected product/service provider by host provider 400 is forwarded to the product/service provider selected by the user. In this manner, host provider 400 can collect be appropriately compensated (i.e., credited) with forwarding the user to the product/service provider

At step 561, if the user indicates that they do not wish to purchase the requested item from a product/service provider 300, then a determination is made whether the user requires additional information concerning the item of the data request (step 563). If additional information is requested, then the user is returned to step 501, shown in FIG. 10a. If additional information is not requested, then no further action is immediately taken and the query data is preferably stored (step 552).

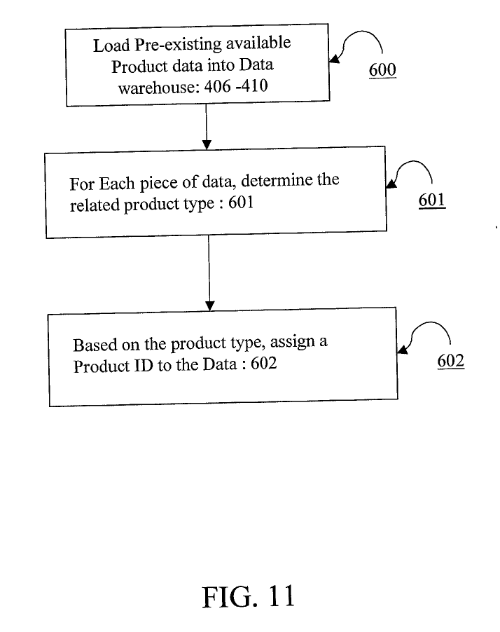

FIG. 11 illustrates a flow diagram of an aspect of the present invention in which a method for loading data to a database of the host provider and assigning a unique ID to that data. Pre-existing data, as well as internally created data, such as individual product details and specifications can be uploaded to the system, per the illustrated process. The data is uploaded to a memory (step 600) and each component of data is linked to a related item type (step 601). Based on the particular item type, a unique item ID is preferably assigned (step 602) to the data, which is then stored in the database.

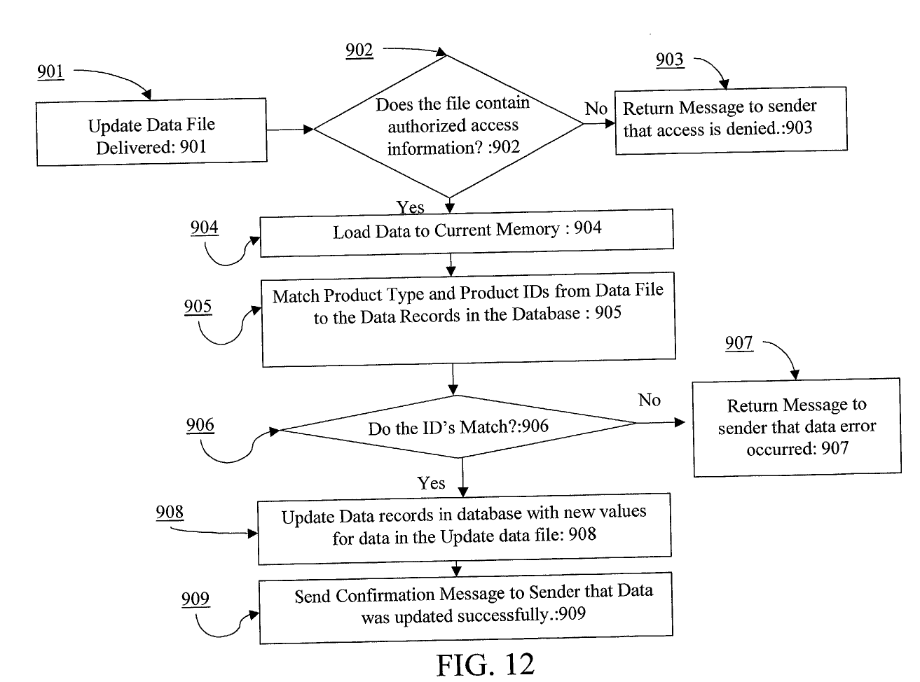

FIG. 12 is a flow diagram of an aspect of the present invention in which a preferred method for allowing product/service providers access to manage, and update the data in the system database, which can reside with the host provider 400. An update data file (step 901) may be periodically required to keep the database updated with respect to available items (e.g., model numbers, new products and features). The data file is analyzed to determine if it includes the authorized access information (step 902). If the file does not contain the authorized access information, then a message is returned to the sender, e.g., product/service provider, that its access to the system database is denied (step 903). If the update file does include the authorized access information, then the data included in the file is loaded to current memory (step 904). The item ID included in the update data is matched to the data records in the database, preferably with cross-checking performed on each record to verify the item type ID (step 905). In step 906, it is determined whether the item and item type IDs on the individual pieces of data match. If there is not a match, then a message is returned to the data provider (step 907), with a copy of the individual data record, indicating that there is a data matching problem with the data update request. If the item type IDs do match (step 906), then the data record in the database is updated with the new values provided the data update file (step 908). Upon the completion of step 908, a confirmation message (e.g., an acknowledgement) is sent to the data submitting product/service provider, indicating that the data is updated.

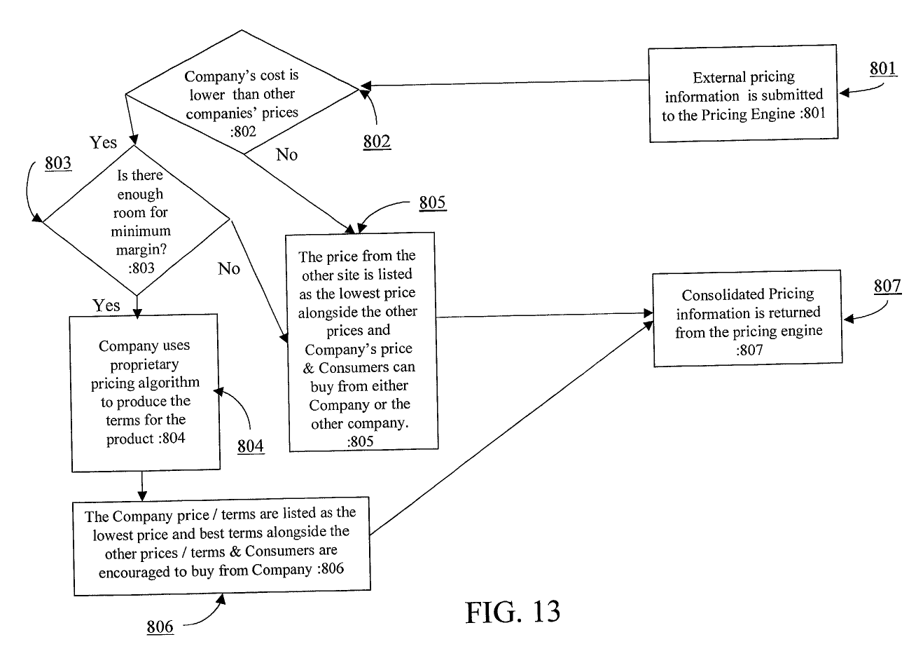

FIG. 13 illustrates a flow diagram of an aspect of the present invention in which a preferred method for the operation of the pricing engine included in host provider 400. As shown in step 801, external pricing information is submitted to the pricing engine. The submitted information is evaluated (step 802) to determine whether the cost available to host provider 400 is lower than the prices available to the user from the product/service providers providing terms of offer in response to a data request. Included in the analysis is an appropriate accounting for the costs of shipping and handling within the quoted price for the cost of an item. If the host provider's total cost, inclusive of the shipping and handling costs analysis, is lower than the price offered by a product/service provider then a determination is made as to whether there is a sufficient a price differential for host provider 400 to provide the requested item at a minimum margin (step 803). Step is accomplished, in one aspect of the invention, by inserting a predetermined percentage or dollar amount over costs. If the answer at steps 802 or 803 is no, then the prices provided by the product/service providers are listed (step 805), with the lowest price being indicated. The host provider's 400 price is also included, so that users can make an informed decision.

If, in step 803, the answer is yes (i.e., there is a sufficient price differential for the host provider's minimum margin), then host provider's 400 uses a pricing algorithm or pricing model to produce the terms of offer for the item (step 804). The factors considered in the pricing model may include, but are not limited to, overall economic factors; the availability the item and the price at which others are offering the item; the user's propensity to buy through the system in the past; and the length of time that the item search request has been ongoing.

From steps 805 and 806, the pricing information is returned from the pricing engine. The system 100 then lists the host provider's price 400 as the lowest price, alongside the prices and terms of the other product/service providers. In this manner, the user is encouraged to purchase from the host provider (806) by the comparative and variable pricing system of the present invention.

It should be understood that the foregoing description is only illustrative of the present invention. Various alternatives and modification can be devised by those skilled in the art without departing from the scope of the invention.

Accordingly, the present invention is intended to embrace all such alternatives, modification and variances which fall within the scope of the appended claims.

What we claim is:

1. A method for providing a comparative listing of providers of an item, said method comprising the steps of:
requesting a term of offer related to said item;
obtaining said requested term of offer for said item from at least one product/service provider;
adjusting, in response to obtaining said requested term of offer for said item, a second term of offer for said item from a host provider; and
presenting said requested term of offer for said item obtained from said at least one product/service provider and said adjusted requested term of offer from said host provider to a data requester device over a communications link.

2. The method of claim 1, wherein said step of requesting said term of offer for said item is in response to a user initiated request.

3. The method of claim 1, wherein said step of requesting said term of offer is enabled by said data requester device.

4. The method of claim 3 wherein said data requester device is selected from the group consisting of a bar code scanner, a portable processor, a wireless telecommunication device, a computer, an information appliance, and a hand-held computing device.

5. The method of claim 1, wherein said communications link comprises a network of computers.

6. The method of claim 5, wherein said network of computers is the Internet.

7. The method of claim 1, wherein said step of requesting said term of offer for said item is selected from the group consisting of requesting the price of said item, requesting the delivery charge of said item, requesting the description of said item, requesting the finance charge of said item, requesting the delivery schedule of said item, and requesting data pertaining to the quality of said item.

8. The method of claim 1, wherein said step of obtaining said requested term of offer from said at least one product/service provider includes obtaining said requested term of offer from a database managed by said at least one product/service provider.

9. The method of claim 1, wherein said step of obtaining said requested term of offer from said at least one product/service provider includes obtaining said requested term from a database managed by said host provider or by way of a system controlled by said host provider.

10. The method of claim 1, wherein said step of adjusting said second term of offer for said item comprises determining if said host provider itself offers said item.

11. The method of claim 1, wherein said step of adjusting said second of offer for said item comprises determining if said host provider can obtain said item from another provider of said item.

12. The method of claim 1, wherein said step of adjusting said second term of offer of said item comprises varying said second term of offer of said item to include a minimum price margin for said host provider.

13. The method of claim 1, wherein said step of adjusting the term of offer for said item from said host provider comprises varying the terms of offer of said item based on a pricing model.

14. The method of claim 13, wherein said pricing model includes varying said second term of offer of said item based on said term of offer as obtained from said at least one product/service provider.

15. The method of claim 13, wherein said pricing model includes varying said second term of offer of said item based on a propensity of a user to purchase said item.

16. A system for providing a comparative listing of providers of an item over a communication link by a host provider, comprising:
a data requester device for requesting a term of an offer related to said item, and presenting said requested term of offer for said item;
a product/service provider interface for providing an interface to at least one product/service provider that provides the term of offer for said item;
a host provider for providing a second term of offer for said item; and
means for adjusting, in response to obtaining said requested term of offer for said item from said product/service provider, said second term of offer for said item from said host provider.

17. The system of claim 16, wherein said system enables the user to initiate said request for said term of offer.

18. The system of claim 16, wherein said data requester device is selected from a group consisting of a bar code scanner, a portable processor, a wireless or wired communication device, a computer, an Internet appliance, and a hand-held computer.

19. The system of claim 16, wherein said communications link comprises a network of computers.

20. The system of claim 19, wherein said network of computers is the Internet.

21. The system of claim 16, wherein said requested term of offer is selected from the group consisting of the price of said item, a delivery charge for said item, a finance charge of said item, a delivery schedule of said item, data pertaining to said item, and a description of said item.

22. The system of claim 16, wherein said term of offer is obtained from a database managed by said product/service provider.

23. The system of claim 16, wherein said term of offer is obtained from a database managed by said host provider.

24. The system of claim 16, wherein said adjusting means determines if said host provider offers said item.

25. The system of claim 16, wherein said adjusting means determines if said host provider can obtain said item from a provider of said item.

26. The system of claim 16, wherein said adjusting means varies the term of offer of said item to include a minimum price margin for said host provider.

27. The system of claim 16, wherein said adjusting means varies the term of offer of said item from said host provider based on a pricing model.

28. The system of claim 27, wherein said pricing model includes varying said term of offer of said item based on said term of offer as obtained from said product/service provider.

29. The system of claim 27, wherein said pricing model includes varying said second term of offer of said item based on a propensity of a user to purchase said item.
